(19) United States
(12) Patent Application Publication
(10) Pub. No.: US 2012/0049503 A1
(43) Pub. Date: Mar. 1, 2012

(54) Spiral-Bound School Notebook Including Advertising Content

(76) Inventors: Alexander V. Garashchenko, Newtown, PA (US); Klajdi Cake, Philadelphia, PA (US)

(21) Appl. No.: 12/869,233

(22) Filed: Aug. 26, 2010

(51) Int. Cl. B42D 1/00; B42F 21/00; B42D 15/00; B42D 3/00

(52) U.S. Cl. 281/27.3; 281/29; 283/39; 283/56

(57) ABSTRACT

A notebook for use by a student attending a school is disclosed. The notebook includes a front cover, a back cover, a binding mechanism, and a plurality of writing paper sheets. Each sheet includes advertising content and a useable portion thereunder which can be utilized by a student for taking notes during class. The notebook may include a divider to separate the writing sheets into multiple subjects. The advertising content may be for local or national businesses. The advertising content is arranged in a predetermined manner throughout the notebook and includes an advertiser's logo in combination with artwork depicting the culture of a particular school or university, or in combination with artwork depicting the advertiser's culture.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### INCORPORATION-BY-REFERENCE OF MATERIAL SUBMITTED ON A COMPACT DISK

“Not Applicable”

### FIELD OF THE INVENTION

The invention relates generally to spiral bound notebooks, and more particularly to a spiral bound notebook including advertising content.

### BACKGROUND OF THE INVENTION

Coil bound notebooks are often used by students, professionals and other users to provide paper and writing surfaces for notes, homework assignments, sketches and the like. The notebook may also include a plurality of tab dividers, pockets, pouches, or other organizational features for receiving loose papers or other items, and typically include a wire or plastic coil that binds the papers, covers, pockets, dividers, and other components of the notebook together. In this manner, a coil bound notebook is a versatile, flexible tool which can serve as an organizer, storage device, paper dispenser and writing tablet.

An example of a spiral notebook sold to and used by students in colleges, universities and other schools is a multi-subject notebook having a flexible front cover and a stiff back cover, each with a storage pocket, and 200 sheets of perforated college ruled writing paper between the covers. The pages can tear out to full 8½×11 inch sheets. The notebook is held together by a metal spiral binder. The notebook includes one or more dividers for separating the writing paper sheets into different subjects. Students can attach labels to the dividers indicating the class or subject matter associated with each respective notebook section. Printed on its front and back covers, the notebook may include inch and/or centimeter rulers, conversion tables and formulae, a U.S. map with time zones and state capitals, computer key combinations and a space for writing phone numbers. This type of notebook can be rather expensive for many students, especially when such students must purchase more than one notebook to accommodate all of their classes.

Businesses large and small are keenly interested in reaching college students through a variety of different types of advertising media. With hundreds of billions in spending power per year, the college market commands attention and offers a unique opportunity for marketing goods and services to college students. Away from the influence of home, college students make hundreds of first-time, independent buying decisions. These buying decisions will influence their preferences and purchasing habits for years to come. The ability to engage college students requires specialized skills, knowledge, and capabilities. In the past, businesses have succeeded in marketing to college students in a variety of ways such as ad placement in college newspapers, online advertising and promotion, email, college print advertising, samples delivered into the hands of college students, college bookstore media, movie screenings, college events, and nightlife media, such as strategically placed ads in the common areas and restrooms of bars, nightclubs and restaurants. Businesses have even gone so far as to include advertisements within coil bound notebooks used by students during class. However, advertisements appearing in these notebooks have usually been restricted to the dividers, covers, or surfaces other than the writing pages to provide the same amount of useable space as provided in standard notebooks so students will not be reluctant to use notebooks including such advertisements. In many cases, such advertisements fail to capture the hearts and minds of students because they do not include content relating to culture on campus that would encourage a student to identify with the business behind the advertisement and purchase its goods and services.

Accordingly, there is a need for a multi-subject spiral bound student notebook that is low cost and can be provided to students free-of-charge through paid-for co-branded advertising, wherein the advertising is placed directly upon the writing pages of the notebook, rather than on dividers, covers or other places where such advertising will go unnoticed by students. In this manner, advertisers can more effectively increase sales and brand awareness while showing that they support college students. Moreover, there is a need for a student notebook wherein such advertising will not take away from space to be utilized by the students for note taking during class. Finally, there is a need for advertising appearing in such notebooks that includes content about campus culture that encourages students to connect with these advertisers thus increasing the likelihood that students will purchase the goods and services being advertised. Likewise, there is a need for advertising appearing in such notebooks that includes content about the advertiser's culture to encourage students to purchase such goods and services being advertised.

### SUMMARY OF THE INVENTION

A notebook for use by a student attending a school is disclosed. The notebook includes a front cover, a back cover, a binding mechanism, such as a spiral binding mechanism, and a plurality of writing paper sheets. Each sheet includes advertising content and a useable portion thereunder which can be utilized by a student for taking notes during class. The notebook may include a divider to separate the writing sheets into multiple subjects. The advertising content may be for local or national businesses. The advertising content is arranged in a predetermined manner throughout the notebook and includes an advertiser's logo in combination with artwork depicting the culture of a particular school or university, or in combination with artwork depicting the advertiser's culture.

According to another aspect of the present invention the design of the school notebook may include input from students of the school, such as artwork depicting the culture of the school, such as a college or university.

According to another aspect of the present invention the design of the school notebook can include the school name, logo, mascot, seal or other identifying indicia on the front cover.

Other objects and advantages of the present invention will become more apparent to those persons having ordinary skill in the art to which the present invention pertains from the foregoing description taken in conjunction with the accompanying drawings.

### BRIEF DESCRIPTION OF THE DRAWINGS

FIG. 1 is a elevational view of the front side of a writing sheet bound within a notebook of the present invention;

FIG. 2 is an elevational view of the back side of a writing sheet bound within a notebook of the present invention; and,

FIG. 3 is a perspective view of a notebook including advertising content of the present invention.

### DETAILED DESCRIPTION OF PREFERRED EMBODIMENTS

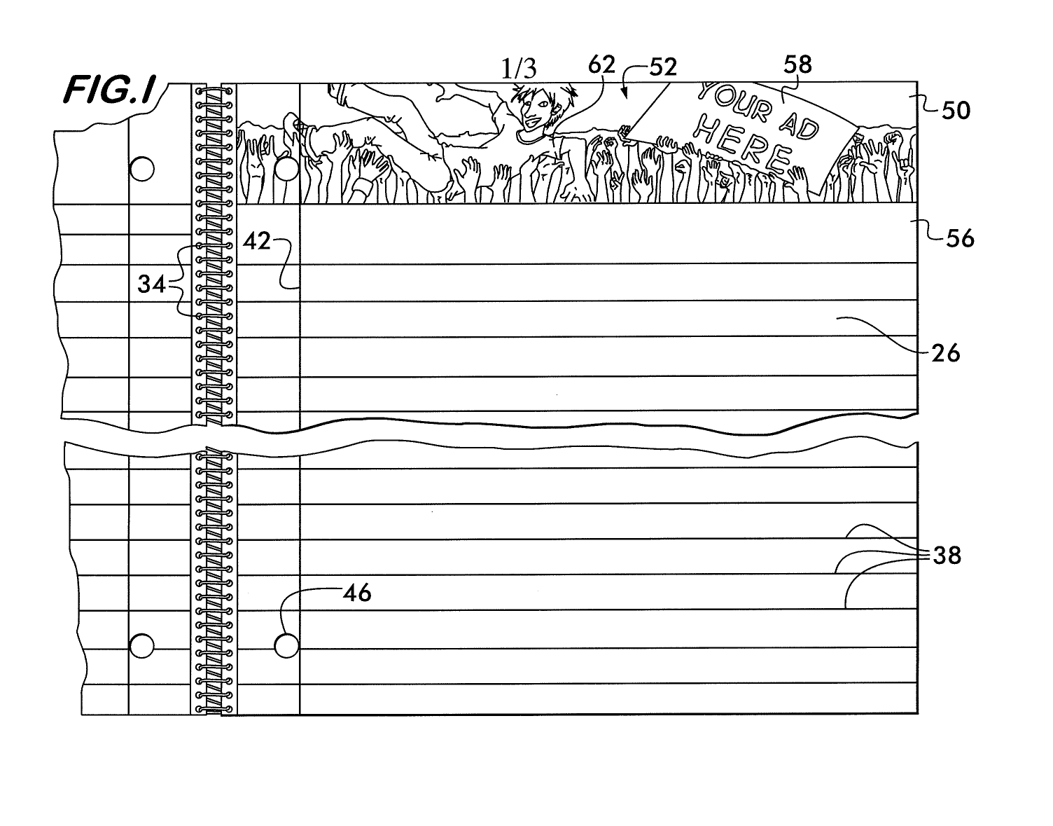

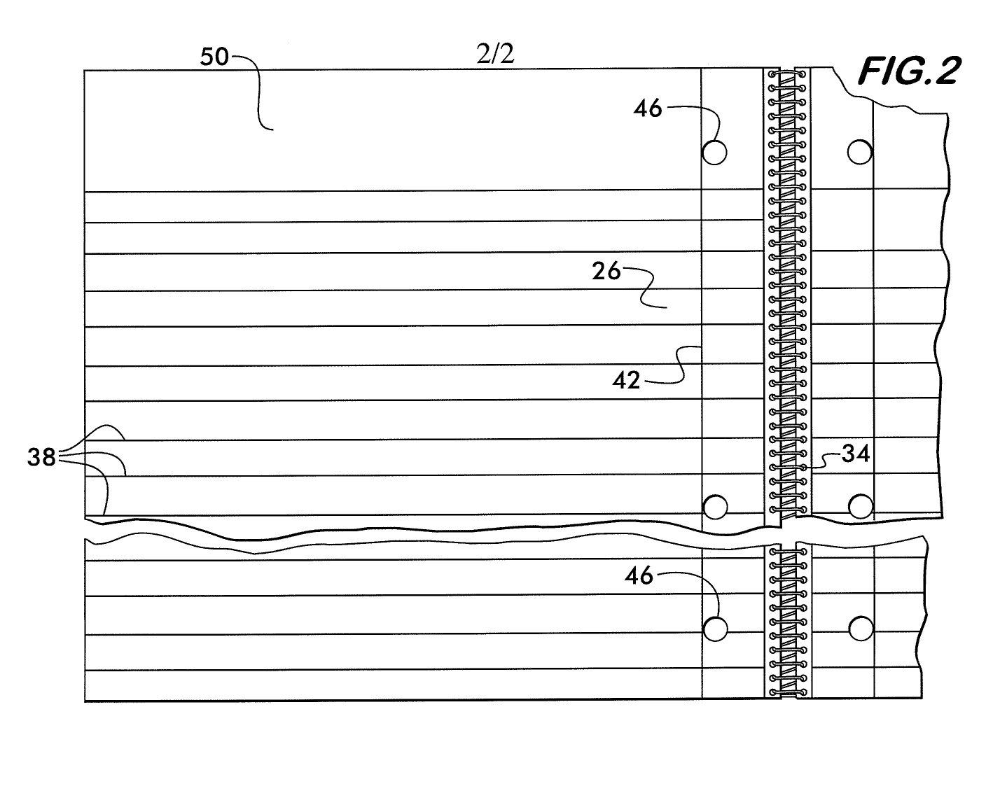

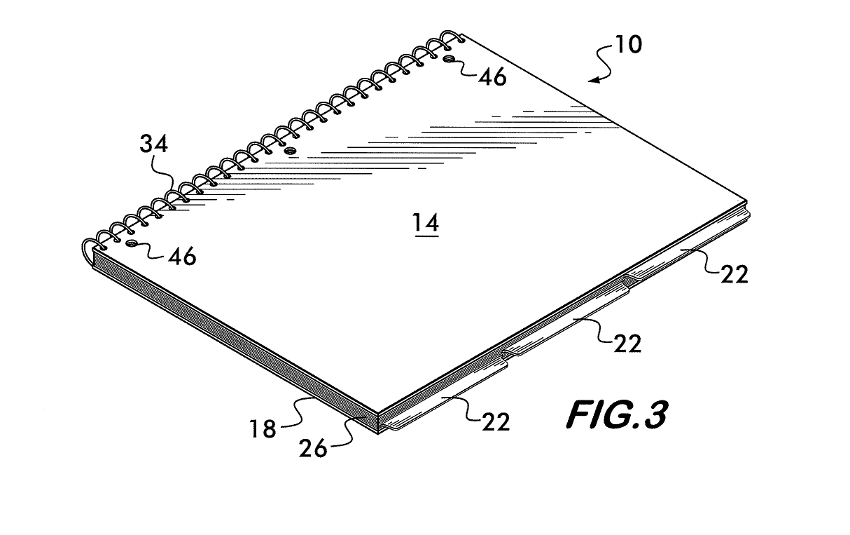

Referring now in detail to the various figures of the drawings wherein like reference characters refer to like parts, there is shown at 26 in FIGS. 1 through 3, a writing paper sheet 26 located within a spiral-bound notebook 10 (FIG. 3) of the present invention. The writing paper sheet 26 includes advertising content. FIG. 1 shows the front side of the writing paper sheet 26 and FIG. 2 shows the back side of the writing paper sheet 26. Referring now to FIG. 3, the notebook 10 is intended for student recipients at one or more schools. The notebook 10 includes a front cover 14 and a back cover 18, each of which can be approximately one millimeter thick and include one or more glossy surfaces. The front cover 14 can be a customized cover having a school's particular design thereon, which can include the name, logo, mascot or other identifying information for the school. The notebook 10 may include one or more tab dividers 22 for separating the writing paper sheets 26 situated between the front and back covers 14, 18 into different subjects. As best shown in FIG. 3, the tab dividers 22 include tabs to provide ready access to the set of writing paper sheets 26 following the tabbed dividers 22. The tabs can also include surfaces on which the student can attach labels or write indicia indicating the class or subject matter associated with each of the respective notebook sections. Instead of having a tab divider, each of the dividers 22 can have a greater width than the width of the writing paper sheets 26 thereby allowing easy access by the user's fingers. Each divider may be approximately 1.0 millimeters mm in thickness.

The writing paper sheets 26 can be any number of suitable sheets, e.g., one hundred sheets minimum, or two hundred sheets maximum. Under the preferred embodiment, the notebook 10 includes approximately one hundred and twenty writing paper sheets 26 divided into three groups of forty sheets each, the three groups being separated by two tab dividers 22, each group being a different school subject. For example, the entire notebook 10 including each sheet of writing paper 26 could measure 9 inches in width and 12 inches in height. These dimensions are slightly larger than a standard sized notebook which typically measures 8.5×11 inches. The writing paper sheets 26 can be 20 pound and 96 brightness. Referring now to FIGS. 1 and 2, the writing paper sheets 26 can be medium or College ruled, meaning that each sheet 26 consists of a plurality of horizontal lines 38 having spaces of a predetermined distance, e.g., 9/32 inch, therebetween. The horizontal lines 38 are provided to separate lines of hand-written text, such as notes taken by students during class. The horizontal lines 38 may be of any suitable color and preferably a darker color, e.g., Cerulean blue. The writing paper sheets 26 are also provided with at least one vertical line 42 located about 1¼ inches from the left edge of the page of the writing paper 26 to provide a left margin. The vertical line 42 may be of any suitable lighter color, e.g., Daffodil. Preferably, the vertical line 42 is of a lighter color so it will not interfere with advertising content appearing in the upper margin 50, to be discussed below. The writing paper sheets 26 may also be provided with 3-hole punches 46 to enable securement of the writing paper sheets 26 within a three-ring binder. A spiral binding 34 is used to bind the front and rear covers 14, 18, writing papers, and other components of the notebook together. The binding 34 may be formed of a suitable wire or plastic.

Referring now to FIG. 1, at the top portion of each writing paper sheet 26 there is located a margin 50. On the front side of the writing paper sheet 26, advertising content 52 is shown located within the margin 50. For example, as best shown in FIGS. 1 and 2, the margin measures 9 inches in width and 2 inches in height. Although the advertising content 52 occupies space of each writing paper sheet 26 within the margin 50, due to its larger dimensions of 9×12 inches, the writing paper sheet 26 of the present invention provides approximately the same amount of useable space as the standard 8.5×11 inch notebook page.

Rather than placing advertisements on the front cover, back cover, or a divider between writing sheets, where such advertisements may go unnoticed, under the present invention, advertisements are placed directly upon the writing paper sheets 26 in the margin 50 just above where students take notes, so that students will be exposed to the advertisement for a longer period of time, especially during class while taking such notes. In this manner, advertisers can more effectively increase sales and brand awareness while showing that they support college students by providing the notebooks 10 to students free of charge. Moreover, because the writing paper sheets 26 of the notebook 10 provide approximately the same amount of useable space to students, including a useable top margin indicated at 56 and the same number of equivalently spaced horizontal lines 38 as in standard notebook pages, students will readily accept such notebooks 10 and utilize them during class on a day-to-day basis as they would standard sized notebooks. Referring now to FIG. 2, there is shown therein the reverse side of the writing paper sheet 26. The reverse side does not include any advertising content in the upper margin 50 or elsewhere, thus providing the student with more useable space for note taking, and moderating the amount of advertising to which the student is exposed.

Alternatively, instead of locating the advertising content 52 within the top margin 50 of the sheet 26, the advertising content 52 could be positioned at other locations on the sheet 26. For example, the advertising content 52 could be positioned along a right-hand margin (not shown) of the sheet 26, such a right-hand margin having dimensions similar to the left margin 42. Alternatively, the advertising content 52 could be positioned within a lower margin (not shown) located at the bottom of the sheet 26, the lower margin having dimensions similar to the upper margin 50. Moreover, advertising content 52 could be positioned within a top margin and within the right-hand margin simultaneously, if required, or the bottom and right-hand margins simultaneously, if required. Regardless of the location of the advertising content 52, the useable space provided on the sheet 26 remains approximately the same as on standard notebook pages.

Referring again to FIG. 1, the advertising content 52 includes two main components. The first is an advertiser's logo indicated at 58. The second is a custom artistic design indicated at 62. The custom artistic design 62 surrounds and incorporates the advertiser's logo therein. The custom artistic design 62 reflects a college's particular culture, and in combination with the advertiser's logo 58, encourages students to make a connection with the advertiser, thus increasing the likelihood that students will purchase the goods and services being advertised. Alternatively, the custom artistic design 62 could reflect the advertiser's culture or theme. For example, if the advertiser is a chain of theme restaurants that features rock 'n roll memorabilia, then that theme, e.g., rock 'n roll memorabilia, could be included in the custom artistic design 62 in combination with the advertiser's logo.

Each college or university has its own unique culture that can change rather rapidly over time. To capture this, the custom artistic design 62 could be created by one or more art students enrolled at the particular college or university to which the notebooks 10 are to be distributed, working in conjunction with the advertiser to create an ad campaign unique to that particular college or university. Such art students could be utilized for the purpose of generating ideas about school culture and creating the custom artistic design 62 within margin 50. Such students who are immersed in the culture at that particular school or surrounding colleges or universities are in a unique position to effectively convey the culture at that particular school and combine it with an advertiser's logo in an effective manner that encourages students to purchase the goods and services being advertised. Thus, notebooks 10 could be customized to the particular college or university where they are to be distributed to students. Moreover, by retaining such art students, either as employees or independent contractors, employment opportunities are provided.

The custom artistic design indicated at 62 depicts students in college culture with the advertiser's logo 58 incorporated therein. The advertising content 52 may be prepared on behalf of one or more businesses located in proximity to the school or on behalf of much larger businesses reaching well beyond the school's local community, e.g., national advertisers. For example, such local businesses could include bars, restaurants, hotels, or taverns located on, or in proximity to, the campus of a particular college or university. Alternatively, the advertising content 52 could be prepared on behalf of national advertisers such as makers of alcoholic beverages, e.g., beer, or soft drinks. The advertising content 52 could be displayed in black and white, or, alternatively, in color. The advertising content 52 could also include text offering discounts, specials or rewards to attract students, such as happy hours, discount nights, or drink specials. In addition, the advertising content 52 could include puzzles or games as a means to engage students and lengthen their exposure to the advertising content 52. The notebook 10 is intended to be provided to students free of charge, as the entire cost of the notebook 10 could be underwritten by the advertiser in exchange for advertisement placement within the notebook 10.

As mentioned previously, under the preferred embodiment, the notebook 10 includes 120 pages separated into three equal groups of forty pages utilizing tab dividers 22. Each group of forty pages represents a different school subject. Each writing paper sheet 26 includes advertising content 52 located within the top margin 50 of the front side of the page. For example, the notebook 10 could be arranged to accommodate up to 30 different advertisers, each of the 30 advertisers being provided with 4 pages of its own advertisement to be strategically placed among 120 total pages of the notebook 10. Strategic placement of the advertisers' pages throughout the notebook is done to maximize each advertiser's impact upon students over the course of a semester.

For example, of the thirty advertisers within the notebook, a first group of ten advertisers could each have one advertisement placed within the first ten pages of the first school subject and a remaining three advertisements placed among the last thirty pages of all three school subjects. A second group of ten advertisers could each have one advertisement placed within the first ten pages of the second school subject and the remaining three advertisements placed among the last thirty pages of all three school subjects. Finally the third group of ten advertisers could each have one advertisement placed within the first ten pages of the third school subject and the remaining three advertisements placed among the last thirty pages of all three subjects. The foregoing exemplary arrangement could be changed based upon the total number of advertisers or based upon the number of advertisers willing to pay a premium for preferred placement within the notebook, e.g., four consecutive pages of the same advertisement within the first ten pages of the first subject section. Other methods for arranging advertisements of different businesses throughout the notebook are within the scope of this invention.

From the foregoing detailed description, it will be evident that there are a number of changes, adaptations and modifications of the present invention which come within the province of those skilled in the art. The scope of the invention includes any combination of the elements from the different species or embodiments disclosed herein, as well as subassemblies, assemblies, and methods thereof. However, it is intended that all such variations not departing from the spirit of the invention be considered as within the scope thereof.

I claim:

1. A notebook for use by a student attending a school, comprising:
a. a front cover and a back cover;
b. a plurality of writing paper sheets, each said sheet including a top margin extending downwardly from a top edge and a useable portion located below said top margin, said top margin including advertising content therein; and,
c. a binding mechanism for binding the covers and writing paper sheets together in a notebook form.

2. The notebook of claim 1, wherein said top margin of each said writing paper sheet is approximately 2 inches in height.

3. The notebook of claim 2, wherein said top margin extends the entire width of the writing paper sheet.

4. The notebook of claim 1, wherein each said writing paper sheet is greater in surface area than a standard writing paper sheet within a notebook.

5. The notebook of claim 4, wherein the useable portion of said writing paper sheet includes a surface area that is approximately equal to that of a standard writing paper sheet.

6. The notebook of claim 5, wherein each said writing paper sheet is approximately 12 inches in height and 9 inches in width.

7. The notebook of claim 1, wherein said binding mechanism is a plastic spiral binder.

8. The of claim 6, wherein each said writing paper sheet includes a plurality of parallel horizontal lines that are equally spaced from one another by a distance of approximately 9/32 inches.

9. The notebook of claim 1, additionally comprising at least one divider for separating writing paper sheets into more than one subject.

10. The notebook of claim 8, wherein said at least one divider includes two divider sheets, and wherein said writing paper includes 120 sheets separated by said two divider sheets into three subjects.

11. The notebook of claim 1, wherein said binding mechanism is a metal spiral binder.

12. The notebook of claim 1, wherein said advertising content is for a local business in proximity to the school's campus.

13. The notebook of claim 1, wherein said advertising content is for a national business.

14. The notebook of claim 1, wherein said advertising content appearing on said writing paper sheets comprises a plurality of advertisements appearing on behalf of different advertisers, one advertisement per writing paper sheet, said advertisements arranged in a predetermined manner thoughout said notebook.

15. The notebook of claim 14, wherein said plurality of writing paper sheets are separated evenly by at least one divider into a plurality of subjects and wherein said plurality of advertisements are arranged in a predetermined manner throughout said notebook.

16. The notebook of claim 15, wherein said plurality of writing paper sheets comprises 120 sheets separated by said two dividers into three subjects, each said subject comprising 40 sheets, and wherein said plurality of advertisements comprises 30 advertisements, each advertisement appearing four times throughout said 120 sheets, one time within the first ten pages of one subject and three times within the last thirty pages of all three subject.

17. The notebook of claim 16, wherein said advertising content comprises a plurality of different advertisements appearing on behalf of a single advertiser.

18. The notebook of claim 1, wherein each said writing paper sheet includes a frontside and a backside, said advertising content appearing on the frontside only of each said writing paper sheet.

19. The notebook of claim 18, wherein said plurality of writing paper sheets comprises one or more preferred writing paper sheets, and wherein an advertiser can pay a premium for placement of an advertisement on said preferred writing paper sheets.

20. The notebook of claim 1, wherein said advertising content comprises a name or logo of an advertiser in combination with artwork depicting the culture of said school.

21. The notebook of claim 1, wherein said advertising content comprises a name or logo of an advertiser in combination with artwork depicting the advertiser's theme.

22. The notebook of claim 21, wherein said artwork includes promotional text or images to attract business from students.

23. The notebook of claim 20, wherein said artwork includes one or more games that can be played by the student.

24. A notebook for use by a student attending a school, comprising:
a. a front cover and a back cover;
b. a plurality of writing paper sheets, each sheet including a portion for inclusion of advertising content thereon and a useable portion providing approximately the same amount of useable space for notetaking as provided on a writing paper sheet of a standard notebook; and,
c. a binding mechanism for binding the covers and writing paper sheets together in a notebook form.

25. The notebook of claim 24, wherein said portion for inclusion of advertising content comprises a right-hand margin, and wherein said advertising content appears within said right-hand margin.

26. The notebook of claim 24, wherein said portion for inclusion of advertising content comprises a top-margin, and wherein said advertising content appears within said top margin.

27. The notebook of claim 24, wherein said portion for inclusion of advertising content comprises a top-margin and a right-hand margin, and wherein said advertising content appears within said top and right-hand margins.

28. The notebook of claim 24, wherein said portion for inclusion of advertising content comprises a bottom margin, and wherein said advertising content appears within said bottom margin.

29. The notebook of claim 24, wherein said portion for inclusion of advertising content comprises a bottom margin and a right-hand margin, and wherein said advertising content appears within said bottom and right-hand margins.
